(19) United States
(12) Patent Application Publication
(10) Pub. No.: US 2021/0374615 A1
(43) Pub. Date: Dec. 2, 2021

(54) Training a Model with Human-Intuitive Inputs

(71) Applicant: Apple Inc., Cupertino, CA (US)

(72) Inventors: Mark Drummond, Palo Alto, CA (US); Peter Meier, Los Gatos, CA (US); Bo Morgan, Emerald Hills, CA (US); Cameron J. Dunn, Los Angeles, CA (US); Siva Chandra Mouli Sivapurapu, Santa Clara, CA (US)

(21) Appl. No.: 17/397,839

(22) Filed: Aug. 9, 2021

Related U.S. Application Data
(63) Continuation of application No. PCT/US2020/029472, filed on Apr. 23, 2020.
(60) Provisional application No. 62/837,253, filed on Apr. 23, 2019.

(51) Int. Cl. G06N 20/00; G06K 9/62; G06K 9/00; G10L 15/22; G10L 15/26

(52) U.S. Cl. CPC G06N 20/00; G06K 9/6253; G10L 15/26; G10L 15/22; G06K 9/00711

(57) ABSTRACT

In one implementation, a method of generating environment states is performed by a device including one or more processors and non-transitory memory. The method includes displaying an environment including an asset associated with a neural network model and having a plurality of asset states. The method includes receiving a user input indicative of a training request. The method includes selecting, based on the user input, a training focus indicating one or more of the plurality of asset states. The method includes generating a set of training data including a plurality of training instances weighted according to the training focus. The method includes training the neural network model on the set of training data.

### CROSS-REFERENCE TO RELATED APPLICATIONS

This application is a continuation of Intl. Patent App. No. PCT/US2020/029472, filed on Apr. 23, 2020, which claims priority to U.S. Provisional Patent App. No. 62/837,253, filed on Apr. 23, 2019, which are both hereby incorporated by reference in their entirety.

### TECHNICAL FIELD

The present disclosure generally relates to training a model of an asset, and in particular, to systems, methods, and devices for training a model of an asset with human-intuitive inputs.

### BACKGROUND

In various implementations, an extended reality (XR) environment is displayed that includes one or more assets. An asset is associated with a model (e.g., a machine learning model, such as a neural network model) and has a plurality of asset states that change according the model and the XR environment. Training the model can be a tedious task, involving the creation of training data which is manually classified or weighted by a user. Accordingly, to improve the XR experience, various implementations disclosed herein allow training of the model using human-intuitive inputs, such as text, speech, or video.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIG. 2 is a block diagram of an example controller in accordance with some implementations.

FIG. 3 is a block diagram of an example electronic device in accordance with some implementations.

FIG. 4 illustrates a scene with an electronic device surveying the scene.

FIGS. 5A-5J illustrates a portion of the display of the electronic device of FIG. 4 displaying images of a representation of the scene including an XR environment.

FIG. 6A illustrates an environment state in accordance with some implementations.

FIG. 6B illustrates a neural network model in accordance with some implementations.

FIG. 7 is a flowchart representation of a method of training a model in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for training a neural network model of an asset. In various implementations, the method is performed at a device including one or more processors and non-transitory memory. The method includes displaying an environment including an asset associated with a neural network model and having a plurality of asset states. The method includes receiving a user input indicative of a training request. The method includes selecting, based on the user input, a training focus indicating one or more of the plurality of asset states. The method includes generating a set of training data including a plurality of training instances weighted according to the training focus. The method includes training the neural network model on the set of training data.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

A physical environment refers to a physical place that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As an example, the XR system may detect movement of the electronic device presenting the XR environment (e.g., a mobile phone, a tablet, a laptop, a head-mounted device, and/or the like) and, in response, adjust graphical content and an acoustic field presented by the electronic device to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head-mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light sources, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

A human-intuitive user interface is provided to train a neural network model of an asset. In various implementations, the user interface allows for a user to speak a command that is interpreted in training the neural network model. In various implementations, the user interface allows for a user to select a video representative of desired behavior of the asset associated with the neural network model.

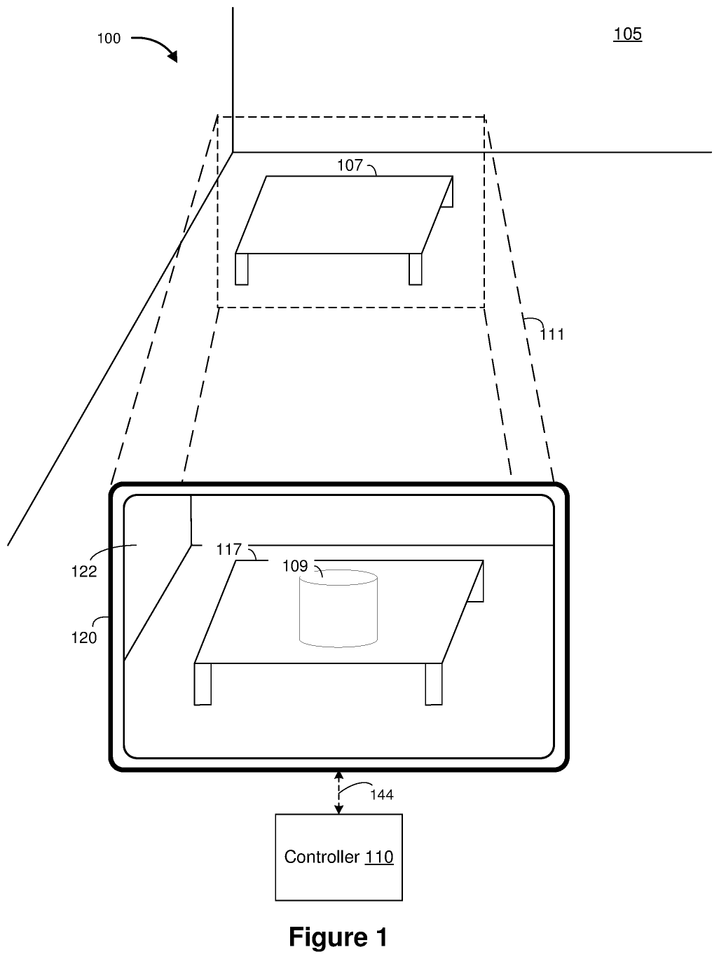

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 110 and an electronic device 120.

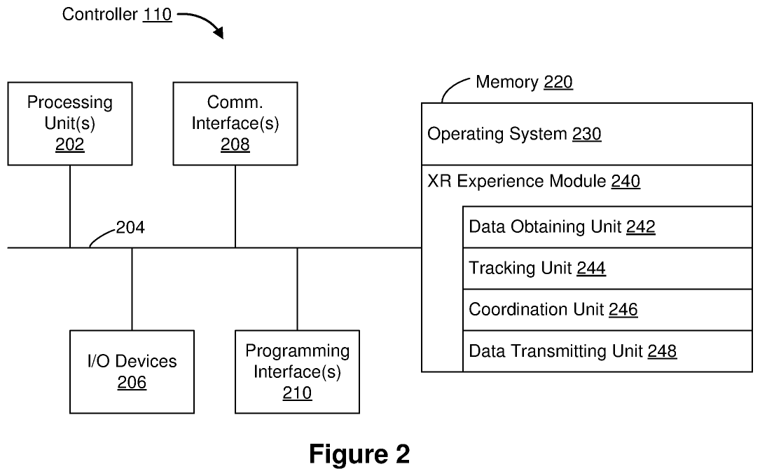

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 2. In some implementations, the controller 110 is a computing device that is local or remote relative to the scene 105. For example, the controller 110 is a local server located within the scene 105. In another example, the controller 110 is a remote server located outside of the scene 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120. In some implementations, the functionalities of the controller 110 are provided by and/or combined with the electronic device 120.

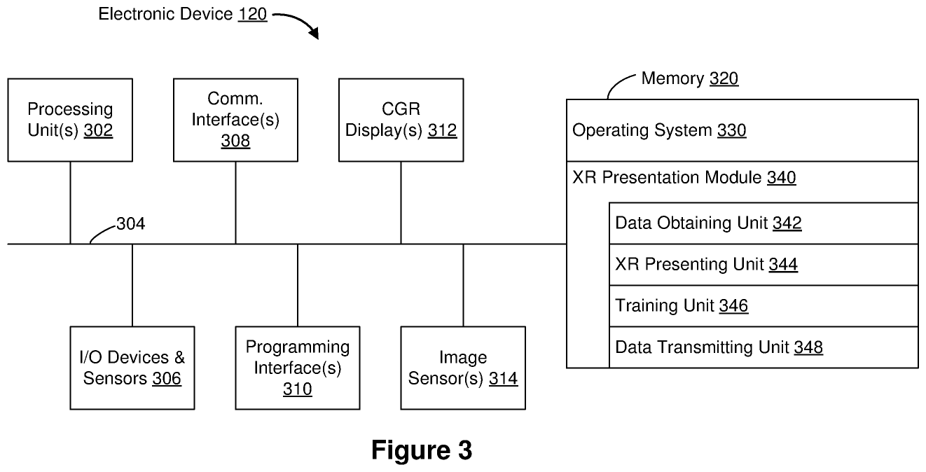

In some implementations, the electronic device 120 is configured to provide the XR experience to the user. In some implementations, the electronic device 120 includes a suitable combination of software, firmware, and/or hardware. According to some implementations, the electronic device 120 presents, via a display 122, XR content to the user while the user is physically present within the scene 105 that includes a table 107 within the field-of-view 111 of the electronic device 120. As such, in some implementations, the user holds the electronic device 120 in his/her hand(s). In some implementations, while providing augmented reality (AR) content, the electronic device 120 is configured to display an AR object (e.g., an AR cylinder 109) and to enable video pass-through of the scene 105 (e.g., including a representation 117 of the table 107) on a display 122. The electronic device 120 is described in greater detail below with respect to FIG. 3.

According to some implementations, the electronic device 120 provides an XR experience to the user while the user is virtually and/or physically present within the scene 105.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more XR displays provided to display the XR content. For example, in various implementations, the electronic device 120 encloses the field-of-view of the user. In some implementations, the electronic device 120 is a handheld device (such as a smartphone or tablet) configured to present XR content, and rather than wearing the electronic device 120, the user holds the device with a display directed towards the field-of-view of the user and a camera directed towards the scene 105. In some implementations, the handheld device can be placed within an enclosure that can be worn on the head of the user. In some implementations, the electronic device 120 is replaced with an XR chamber, enclosure, or room configured to present XR content in which the user does not wear or hold the electronic device 120.

FIG. 2 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some implementations, the one or more communication buses 204 include circuitry that interconnects and controls communications between system components. In some implementations, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some implementations, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some implementations, the memory 220 or the non-transitory computer readable storage medium of the memory 220 stores the following programs, modules and data structures, or a subset thereof including an optional operating system 230 and an XR experience module 240.

The operating system 230 includes procedures for handling various basic system services and for performing hardware dependent tasks. In some implementations, the XR experience module 240 is configured to manage and coordinate one or more XR experiences for one or more users (e.g., a single XR experience for one or more users, or multiple XR experiences for respective groups of one or more users). To that end, in various implementations, the XR experience module 240 includes a data obtaining unit 242, a tracking unit 244, a coordination unit 246, and a data transmitting unit 248.

In some implementations, the data obtaining unit 242 is configured to obtain data (e.g., presentation data, interaction data, sensor data, location data, etc.) from at least the electronic device 120 of FIG. 1. To that end, in various implementations, the data obtaining unit 242 includes instructions and/or logic therefor, and heuristics and metadata therefor.

In some implementations, the tracking unit 244 is configured to map the scene 105 and to track the position/location of at least the electronic device 120 with respect to the scene 105 of FIG. 1. To that end, in various implementations, the tracking unit 244 includes instructions and/or logic therefor, and heuristics and metadata therefor.

In some implementations, the coordination unit 246 is configured to manage and coordinate the XR experience presented to the user by the electronic device 120. To that end, in various implementations, the coordination unit 246 includes instructions and/or logic therefor, and heuristics and metadata therefor.

In some implementations, the data transmitting unit 248 is configured to transmit data (e.g., presentation data, location data, etc.) to at least the electronic device 120. To that end, in various implementations, the data transmitting unit 248 includes instructions and/or logic therefor, and heuristics and metadata therefor.

Although the data obtaining unit 242, the tracking unit 244, the coordination unit 246, and the data transmitting unit 248 are shown as residing on a single device (e.g., the controller 110), it should be understood that in other implementations, any combination of the data obtaining unit 242, the tracking unit 244, the coordination unit 246, and the data transmitting unit 248 may be located in separate computing devices.

Moreover, FIG. 2 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 3 is a block diagram of an example of the electronic device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some implementations, the one or more communication buses 304 include circuitry that interconnects and controls communications between system components. In some implementations, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 312 are configured to provide the XR experience to the user. In some implementations, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 312 correspond to diffractive, reflective, polarized, holographic, etc. waveguide displays. For example, the electronic device 120 includes a single XR display. In another example, the electronic device includes a XR display for each eye of the user. In some implementations, the one or more XR displays 312 are capable of presenting MR and VR content.

In some implementations, the one or more image sensors 314 are configured to obtain image data that corresponds to at least a portion of the face of the user that includes the eyes of the user (any may be referred to as an eye-tracking camera). In some implementations, the one or more image sensors 314 are configured to be forward-facing so as to obtain image data that corresponds to the scene as would be viewed by the user if the electronic device 120 was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some implementations, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some implementations, the memory 320 or the non-transitory computer readable storage medium of the memory 320 stores the following programs, modules and data structures, or a subset thereof including an optional operating system 330 and an XR presentation module 340.

The operating system 330 includes procedures for handling various basic system services and for performing hardware dependent tasks. In some implementations, the XR presentation module 340 is configured to present XR content to the user via the one or more XR displays 312. To that end, in various implementations, the XR presentation module 340 includes a data obtaining unit 342, an XR presenting unit 344, a training unit 346, and a data transmitting unit 348.

In some implementations, the data obtaining unit 342 is configured to obtain data (e.g., presentation data, interaction data, sensor data, location data, etc.) from at least the controller 110 of FIG. 1. To that end, in various implementations, the data obtaining unit 342 includes instructions and/or logic therefor, and heuristics and metadata therefor.

In some implementations, the XR presenting unit 344 is configured to present XR content via the one or more XR displays 312. To that end, in various implementations, the XR presenting unit 344 includes instructions and/or logic therefor, and heuristics and metadata therefor.

In some implementations, the training unit 346 is configured to train one or more neural network models of respective assets. To that end, in various implementations, the training unit 346 includes instructions and/or logic therefor, and heuristics and metadata therefor.

In some implementations, the data transmitting unit 348 is configured to transmit data (e.g., presentation data, location data, etc.) to at least the controller 110. To that end, in various implementations, the data transmitting unit 348 includes instructions and/or logic therefor, and heuristics and metadata therefor.

Although the data obtaining unit 342, the XR presenting unit 344, the training unit 346, and the data transmitting unit 348 are shown as residing on a single device (e.g., the electronic device 120 of FIG. 1), it should be understood that in other implementations, any combination of the data obtaining unit 342, the XR presenting unit 344, the training unit 346, and the data transmitting unit 348 may be located in separate computing devices.

Moreover, FIG. 3 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

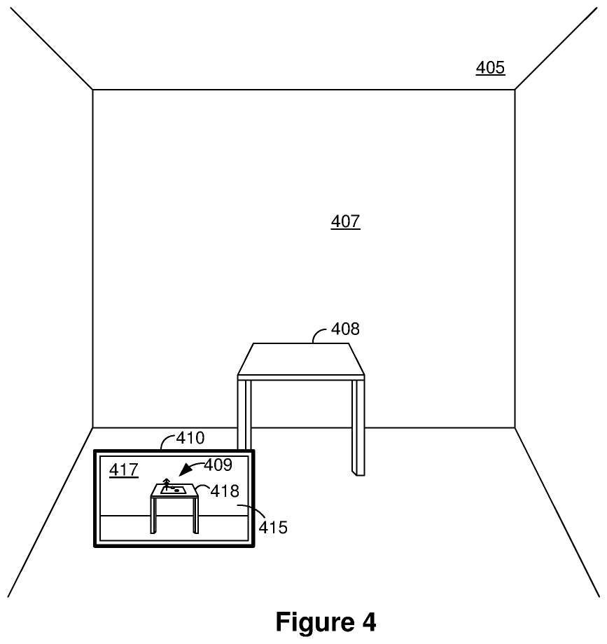

FIG. 4 illustrates a scene 405 with an electronic device 410 surveying the scene 405. The scene 405 includes a table 408 and a wall 407.

The electronic device 410 displays, on a display, a representation of the scene 415 including a representation of the table 418 and a representation of the wall 417. In various implementations, the representation of the scene 415 is generated based on an image of the scene captured with a scene camera of the electronic device 410 having a field-of-view directed toward the scene 405. The representation of the scene 415 further includes an XR environment 409 displayed on the representation of the table 418.

As the electronic device 410 moves about the scene 405, the representation of the scene 415 changes in accordance with the change in perspective of the electronic device 410. Further, the XR environment 409 correspondingly changes in accordance with the change in perspective of the electronic device 410. Accordingly, as the electronic device 410 moves, the XR environment 409 appears in a fixed relationship with respect to the representation of the table 418.

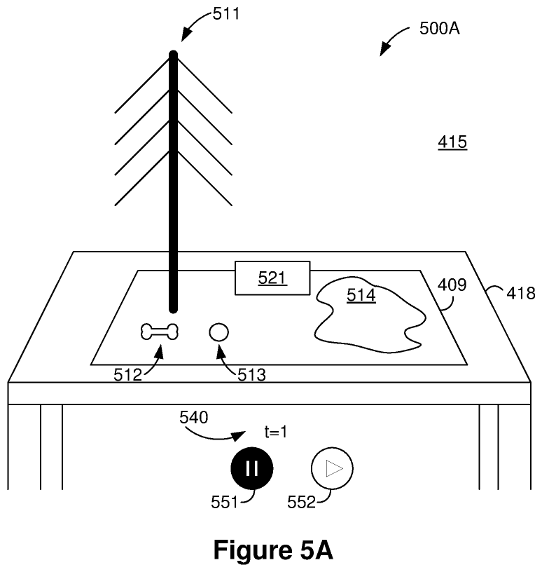

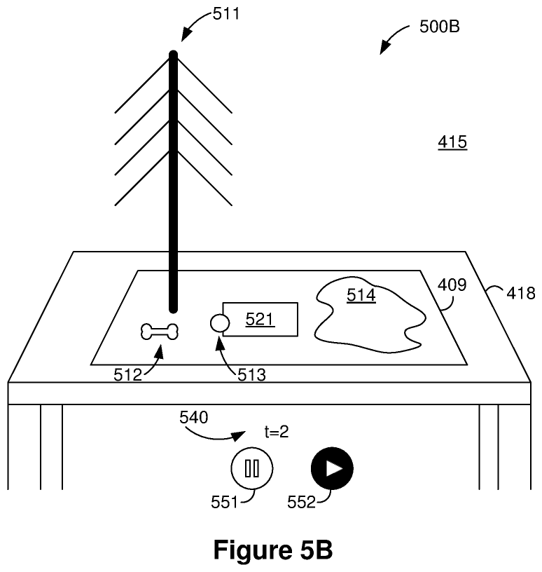

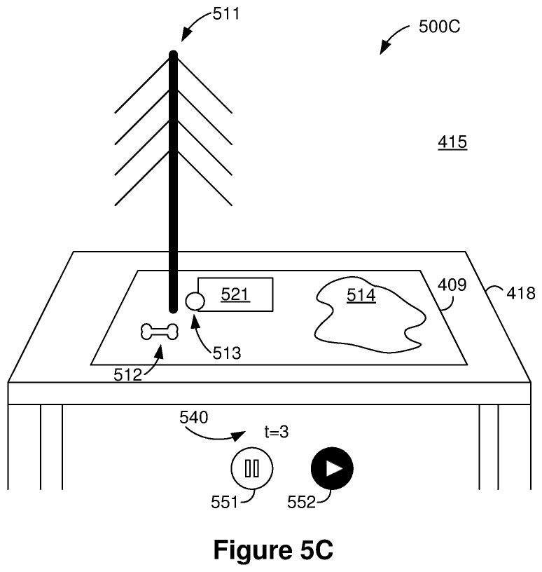

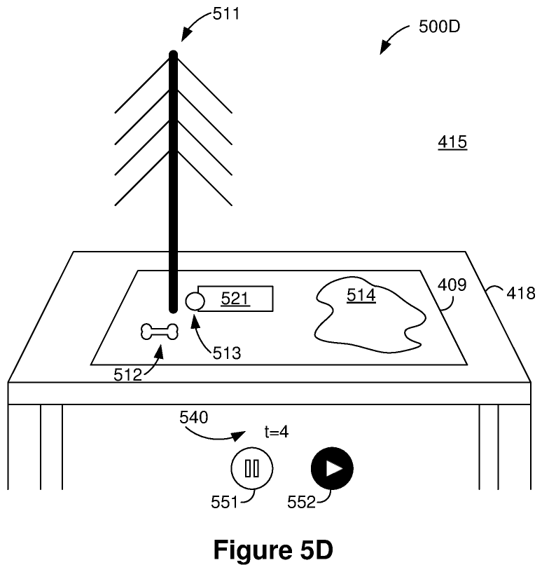

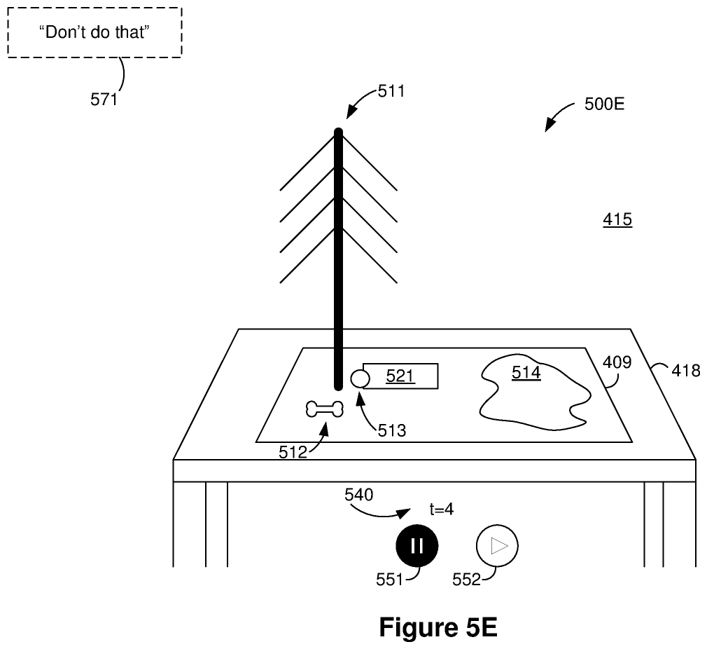

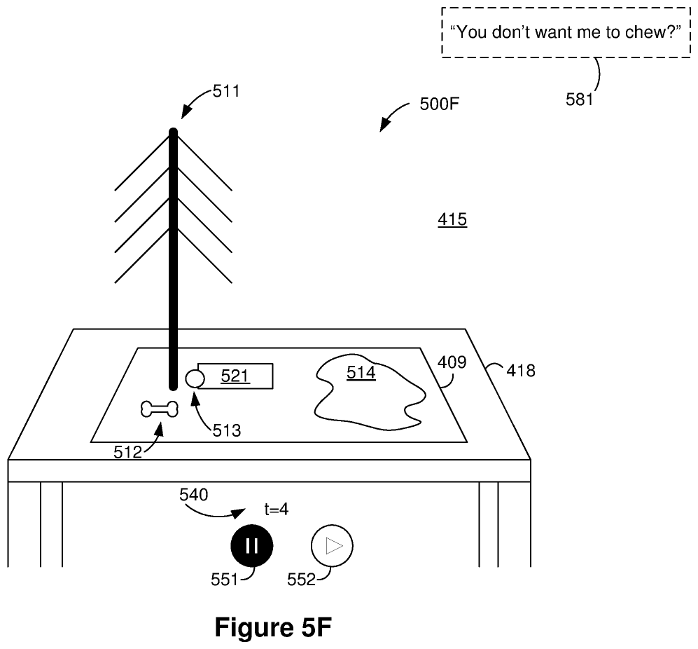

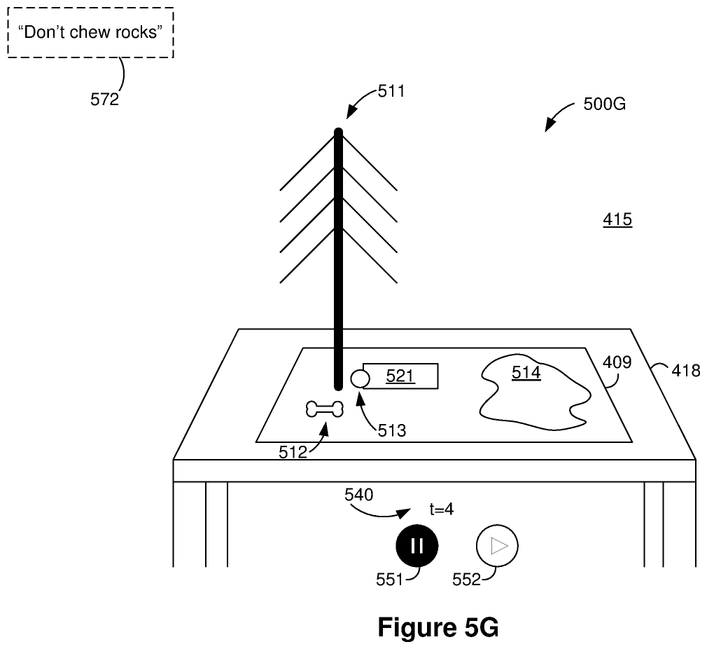

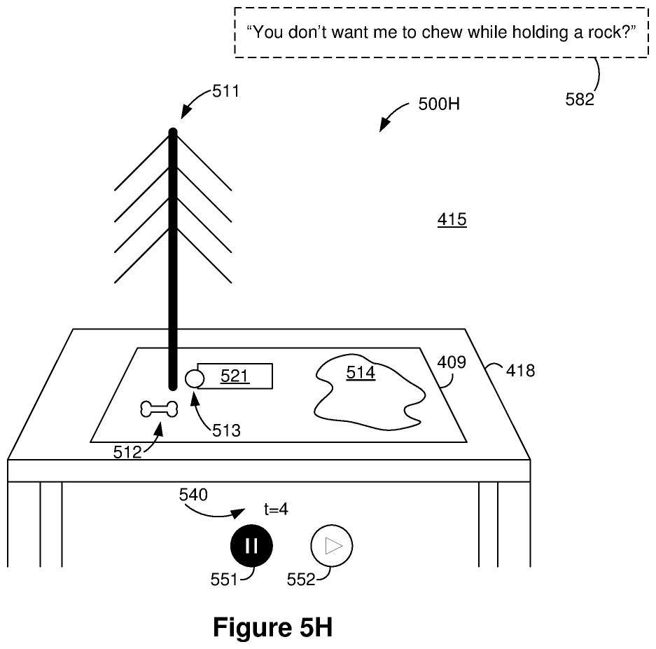

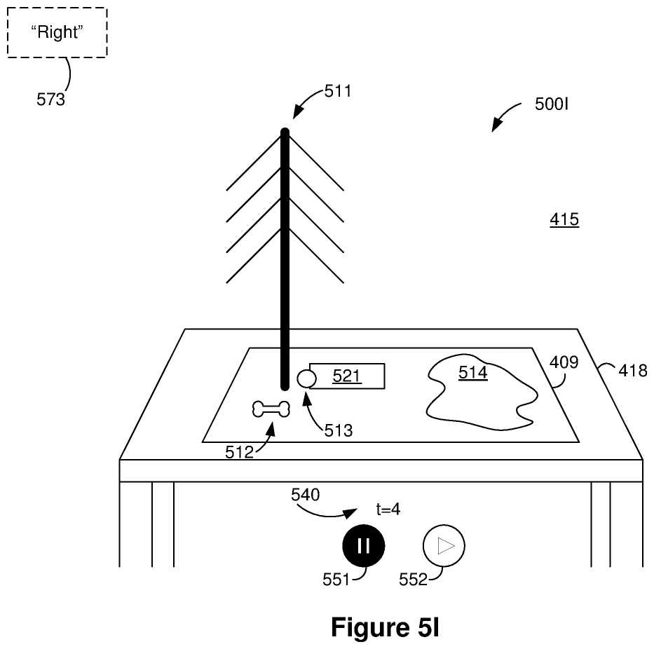

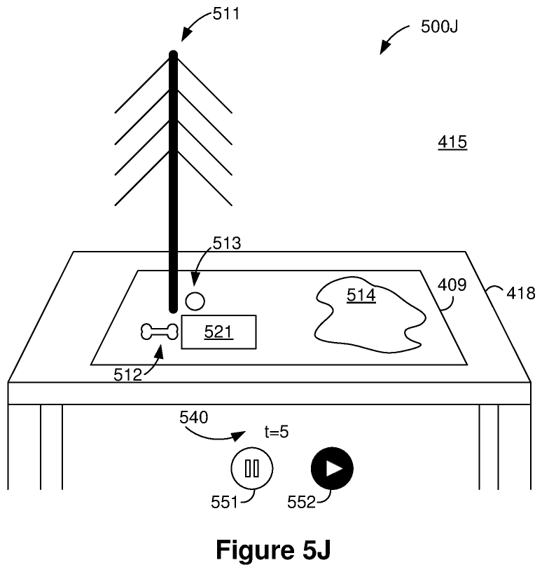

FIG. 5A illustrates a portion of the display of the electronic device 410 displaying a first image 500A of the representation of the scene 415 including the XR environment 409. In FIG. 5A, the XR environment 409 is defined by a first environment state and is associated with a first environment time (e.g., 1). The first environment state indicates the inclusion in the XR environment 409 of one or more assets and further indicates one or more states of the one or more assets. In various implementations, the environment state is a data object, such as an XML file.

Accordingly, the XR environment 409 displayed in the first image 500A includes a plurality of assets as defined by the first environment state. In FIG. 5A, the XR environment 409 includes a tree 511, a bone 512, a rock 513, a puddle of mud 514, and a dog 521 (illustrated by a box).

The first environment state indicates the inclusion of the tree 511 and defines one or more states of the tree 511. For example, the first environment state indicates a first age of the tree 511 and a first location of the tree 511. The first environment state indicates the inclusion of the bone 512 and defines one or more states of the bone 512. For example, the first environment state indicates a level-of-wear of the bone 512, a first location of the bone 512, and a first held state of the bone 512 indicating that the bone 512 is not held by the dog 521. The first environment state indicates the inclusion of the rock 513 and defines one or more states of the rock 513. For example, the first environment state indicates a first location of the rock 513 and a first held state of the rock 513 indicating that the rock 513 is not held by the dog 521. The first environment state indicates the inclusion of the puddle of mud 514 and defines one or more states of the puddle of mud 514. For example, the first environment state indicates a size, shape, and location of the puddle of mud.

The first environment state indicates the inclusion of the dog 521 and defines one or more states of the dog 521. For example, the first environment state indicates a first age of the dog 521, a first location of the dog 521, and a first motion vector of the dog 521 indicating that the dog 521 is moving toward the rock 513.

The first image 500A further includes a time indicator 540, a pause affordance 551, and a play affordance 552. In FIG. 5A, the time indicator 540 indicates a current time of the XR environment 409 of 1. Further, the pause affordance 551 is currently selected (as indicated by the different manner of display).

FIG. 5B illustrates a portion of the display of the electronic device 410 displaying a second image 500B of the representation of the scene 415 including the XR environment 409 in response to a user selection of the play affordance 552 and after a frame period. In FIG. 5B, the time indicator 540 indicates a current time of the XR environment 409 of 2 (e.g., a first timestep of 1 as compared to FIG. 5A). In FIG. 5B, the play affordance 552 is currently selected (as indicated by the different manner of display).

In FIG. 5B, the XR environment 409 is defined by a second environment state and is associated with a second environment time (e.g., 2). In various implementations, the second environment state is generated according to a model and based on the first environment state. In various implementations, the model includes a neural network model associated with one of the assets. In particular, the model includes a neural network model associated with the dog 521.

In various implementations, determining the second environment state according to the model includes determining a second age of the tree 511 by adding the first timestep (e.g., 1) to the first age of the tree 511 and determining a second age of the dog 521 by adding the first timestep (e.g., 1) to the first age of the dog 521.

In various implementations, determining the second environment state according to the model includes determining a second location of the tree 511 by copying the first location of the tree 511. Thus, the model indicates that the tree 511 (e.g., assets having an asset type of “TREE”) do not change location.

In various implementations, determining the second environment state according to the model includes determining a second location of the dog 521 according to the first motion vector of the dog 521. Thus, the first model indicates that the dog 521 (e.g., assets having an asset type of “ANIMAL”) change location according to a motion vector.

In various implementations, determining the second environment state according to the model includes determining a second motion vector of the dog 521 according to the neural network model.

In various implementations, determining the second environment state includes determining a second location of the bone 512 based on the first location of the bone 512 and the first held state of the bone 512. For example, the model indicates that the bone 512 (e.g., assets having an asset type of “INANIMATE”) does not change location when the held state indicates that the bone 512 is not held, but changes in accordance with a change in location of an asset (e.g., the dog 521) that is holding the bone 512.

In various implementations, determining the second environment state includes determining a second location of the rock 513 based on the first location of the rock 513 and the first held state of the rock 513. For example, the model indicates that the rock 513 (e.g., assets having an asset type of “INANIMATE”) does not change location when the held state indicates that the rock 513 is not held, but changes in accordance with a change in location of an asset (e.g., the dog 521) that is holding the rock 513.

In various implementations, determining the second environment state includes determining a second held state of the bone 512 based on the second location of the bone 512 and the second location of the dog 521. For example, the model indicates that the bone 512 (e.g., assets having an asset type of “INANIMATE”) changes its held state to indicate that it is being held by a particular asset having an asset type of “ANIMAL” when that particular asset is at the same location as the bone 512 and performs an action, e.g., based on its neural network model, to pick up the bone 512.

In various implementations, determining the second environment state includes determining a second held state of the rock 513 based on the second location of the rock 513 and the second location of the dog 521. For example, the model indicates that the rock 513 (e.g., assets having an asset type of “INANIMATE”) changes its held state to indicate that it is being held by a particular asset having an asset type of “ANIMAL” when that particular asset is at the same location as the rock 513 and performs an action, e.g., based on its neural network model, to pick up the rock 513.

Accordingly, in FIG. 5B, as compared to FIG. 5A, the dog 521 has moved to the location of the rock 513 and picked it up.

FIG. 5C illustrates a portion of the display of the electronic device 410 displaying a third image 500C of the representation of the scene 415 including the XR environment 409 after another frame period. In FIG. 5C, the time indicator 540 indicates a current time of the XR environment 409 of 3 (e.g., the first timestep of 1 as compared to FIG. 5B). In FIG. 5C, the play affordance 552 remains selected (as indicated by the different manner of display).

In FIG. 5C, the XR environment 409 is defined by a third environment state and is associated with a third environment time. In various implementations, the third environment state is generated according to the model and based on the second environment state. In FIG. 5C, as compared to FIG. 5B, the dog 521 has moved location closer to the tree 511 and the rock 513, held by the dog 521, has moved location with the dog 521.

FIG. 5D illustrates a portion of the display of the electronic device 410 displaying a fourth image 500D of the representation of the scene 415 including the XR environment 409 after another frame period. In FIG. 5D, the time indicator 540 indicates a current time of the XR environment 409 of 4 (e.g., the first timestep of 1 as compared to FIG. 5B). In FIG. 5D, the play affordance 552 remains selected (as indicated by the different manner of display).

In FIG. 5D, the XR environment 409 is defined by a fourth environment state and is associated with a fourth environment time. In various implementations, the fourth environment state is generated according to the model and based on the third environment state. In FIG. 5D, as compared to FIG. 5C, the dog 521 has laid down (as illustrated by a smaller height of the box) and is chewing the rock 513.

FIG. 5E illustrates a portion of the display of the electronic device 410 displaying a fifth image 500E of the representation of the scene 415 including the XR environment 409 after receiving a user input indicative of a training request. In FIG. 5E, the time indicator 540 indicates a current time of the XR environment 409 of 4 and the pause affordance 551 is selected (as indicated by the different manner of display) in response to receiving the user input indicative of a training request.

In various implementations, the user input indicative of a training request includes speech produced by the user. FIG. 5E illustrates a text representation of the speech 571 of the user input indicative of a training request. Although the text representation of the speech 571 is shown in FIG. 5E for purposes of illustration, in various implementations, the text representation of the speech 571 is not displayed.

In response to receiving the user input indicative of a training request, the electronic device 410 trains the neural network model of the dog 521 based on the user input. In various implementations, the electronic device selects, based on the user input, a training focus indicating one or more of the plurality of asset states.

In various implementations, selecting the training focus includes selecting, based on the user input, a potential training focus indicating one or more of the plurality of states and presenting a natural language confirmation of the potential training focus.

FIG. 5F illustrates a portion of the display of the electronic device 410 displaying a sixth image 500F of the representation of the scene 415 including the XR environment 409 presenting a natural language confirmation of a potential training focus. In FIG. 5F, the time indicator 540 indicates a current time of the XR environment 409 of 4 and the pause affordance 551 remains selected (as indicated by the different manner of display).

In various implementations, presenting the natural language confirmation of the potential training focus includes outputting speech produced by the electronic device. FIG. 5F illustrates a text representation of the speech 581 of the natural language confirmation. Although the text representation of the speech 581 is shown in FIG. 5F for purposes of illustration, in various implementations, the text representation of the speech 581 is not displayed.

Thus, in response to receiving a user input of “Don't do that,” the electronic device 410 determines a plurality of candidate training focuses, each indicating a different set of one or more of the plurality of asset states. In FIG. 5E, the dog 521 has asset states including an asset state of “chewing”, an asset state of “holding the rock” 513, an asset state of “lying down”, and an asset state of “being near the tree” 511.

In various implementations, at least one of the plurality of candidate training focuses indicates a single one of the plurality of asset states. Thus, in various implementations, the candidate training focuses include “don't chew”; “don't hold the rock”; “don't lie down”; and “don't be near the tree”. In various implementations, at least one of the plurality of candidate training focuses indicates two or more of the plurality of asset states. Thus, in various implementations, the candidate training focuses include “don't chew AND hold the rock”; “don't chew AND lie down”; “don't lie down AND be near the tree.”

The electronic device 410 ranks the plurality of candidate training focuses. In various implementations, the ranking is based on asset state recency. For example, the candidate training focus of “don't chew” is ranked higher than “don't hold the rock” because the asset state of “chewing” occurred more recently than the asset state of “holding the rock”. In various implementations, the ranking is based on the user input. For example, in various implementations, the user input indicates a training focus, e.g., “Don't eat that” rather than “Don't do that” as shown in FIG. 5E. Accordingly, the candidate training focus of “don't chew” is ranked higher than “don't lie down” because the asset state of “chewing” is semantically related to “eat” and “lying down” is not.

The electronic device 410 selects one of the candidate training focuses as the potential training focus based on the ranking and presents the natural language confirmation of the potential training focus.

FIG. 5G illustrates a portion of the display of the electronic device 410 displaying a seventh image 500G of the representation of the scene 415 including the XR environment 409 in response to receiving user input modifying the potential training focus. In FIG. 5G, the time indicator 540 indicates a current time of the XR environment 409 of 4 and the pause affordance 551 remains selected (as indicated by the different manner of display).

In various implementations, the user input modifying the potential training focus includes speech produced by the user. FIG. 5G illustrates a text representation of the speech 572 of the user input modifying the potential training focus. Although the text representation of the speech 572 is shown in FIG. 5G for purposes of illustration, in various implementations, the text representation of the speech 572 is not displayed.

FIG. 5H illustrates a portion of the display of the electronic device 410 displaying an eighth image 500H of the representation of the scene 415 including the XR environment 409 presenting a natural language confirmation of a modified potential training focus. In FIG. 5H, the time indicator 540 indicates a current time of the XR environment 409 of 4 and the pause affordance 551 remains selected (as indicated by the different manner of display).

In various implementations, presenting the natural language confirmation of the potential training focus includes outputting speech produced by the electronic device. FIG. 5F illustrates a text representation of the speech 581 of the natural language confirmation. Although the text representation of the speech 581 is shown in FIG. 5F for purposes of illustration, in various implementations, the text representation of the speech 581 is not displayed.

Thus, in response to receiving a user input of “Don't chew rocks,” the electronic device 410 re-ranks the plurality of candidate training focuses and selects a new potential training focus, e.g. “don't chew AND hold the rock”. The natural language confirmation presents the new potential training focus as natural language, e.g, “You don't want me to chew while holding a rock?”, rather than “don't chew AND hold the rock?”

FIG. 5I illustrates a portion of the display of the electronic device 410 displaying a ninth image 500I of the representation of the scene 415 including the XR environment 409 in response to receiving user input confirming the new potential training focus. In FIG. 5I, the time indicator 540 indicates a current time of the XR environment 409 of 4 and the pause affordance 551 remains selected (as indicated by the different manner of display).

In various implementations, the user input confirming the new potential training focus includes speech produced by the user. FIG. 5I illustrates a text representation of the speech 573 of the user input modifying the potential training focus. Although the text representation of the speech 573 is shown in FIG. 5I for purposes of illustration, in various implementations, the text representation of the speech 573 is not displayed.

FIG. 5J illustrates a portion of the display of the electronic device 410 displaying a tenth image 500J of the representation of the scene 415 including the XR environment 409 after another frame period. In FIG. 5J, the time indicator 540 indicates a current time of the XR environment 409 of 5 (e.g., the first timestep of 1 as compared to FIG. 5I). In FIG. 5J, the play affordance 552 is selected (as indicated by the different manner of display) in response to the user input confirming the new potential training focus.

In FIG. 5J, the XR environment 409 is defined by a fifth environment state and is associated with a fifth environment time. In various implementations, the fifth environment state is generated according to the model (including a retrained neural network model of the dog 521) and based on the fourth environment state. In FIG. 5J, as compared to FIG. 5I, the dog 521 has stood up and moved location closer to the bone 512.

In response to receiving the user input confirming the new potential training focus, the electronic device 410 selects the new potential training focus as the training focus and generates a set of training data including a plurality of training instances weighted according to the training focus. Thus, the set of training data includes training instances, e.g., simulations of behavior of the dog 521, which, where the training focus occurs, it is weighted positively or negatively. The electronic device 410 trains the neural network model on the set of training data and a next environmental state is generated based on the model, updated by the training of the neural network model on the set of training data.

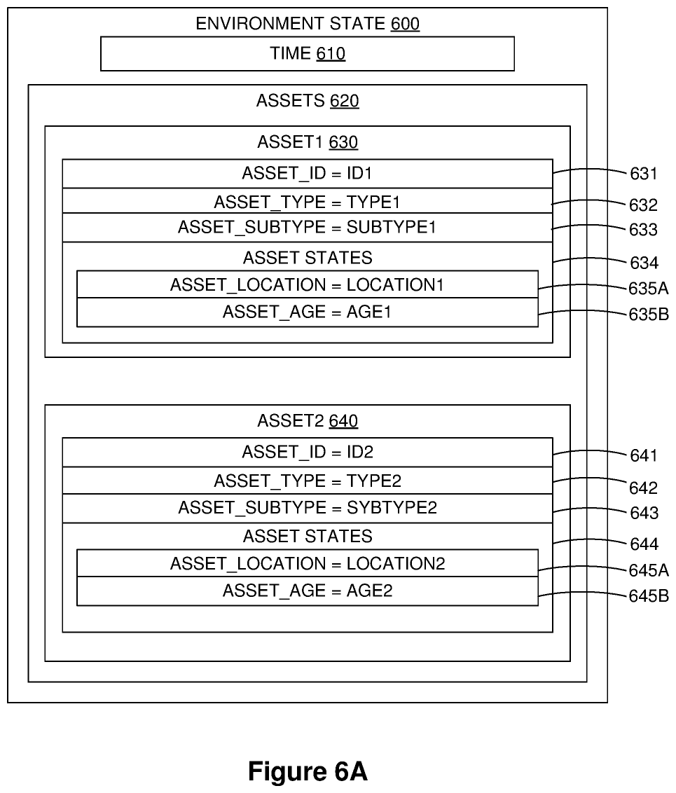

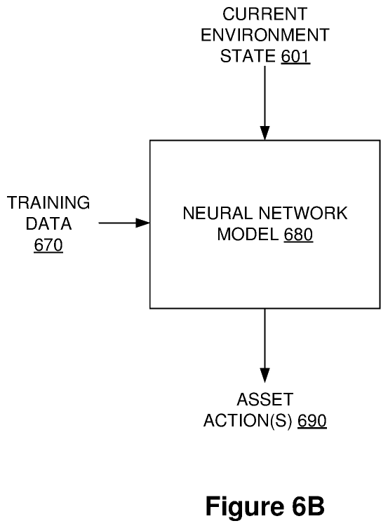

FIG. 6A illustrates an environment state 600 in accordance with some implementations. In various implementations, the environment state 600 is a data object, such as an XML file. The environment state 600 indicates inclusion in an XR environment of one or more assets and further indicates one or more states of the one or more assets.

The environment state 600 includes a time field 610 that indicates an environment time associated with the environment state.

The environment state 600 includes an assets field 620 including a plurality of individual asset fields 630 and 640 associated with respective assets of the XR environment. Although FIG. 6 illustrates only two assets, it is to be appreciated that the assets field 620 can include any number of asset fields.

The assets field 620 includes a first asset field 630. The first asset field 630 includes a first asset identifier field 631 that includes an asset identifier of the first asset. In various implementations, the asset identifier includes a unique number. In various implementations, the asset identifier includes a name of the asset.

The first asset field 630 includes a first asset type field 632 that includes data indicating an asset type of the first asset. The first asset field 630 includes an optional asset subtype field 633 that includes data indicating an asset subtype of the asset type of the first asset.

The first asset field 630 includes a first asset states field 634 including a plurality of first asset state fields 635A and 635B. In various implementations, the assets state field 634 is based on the asset type and/or asset subtype of the first asset. For example, when the asset type is “TREE”, the asset states field 634 includes an asset location field 635A including data indicating a location in the XR environment of the asset and an asset age field 635B including data indicating an age of the asset. As another example, when the asset type is “ANIMAL”, the asset states field 634 includes an asset motion vector field including data indicating a motion vector of the asset. As another example, when the asset type is “INANIMATE”, the asset states field 634 includes an asset held state field including data indicating which, if any, other asset is holding the asset. As another example, when the asset type is “WEATHER”, the asset states field 634 includes an asset temperature field including data indicating a temperature of the XR environment, an asset humidity field including data indicating a humidity of the XR environment, and/or an asset precipitation field including data indicating a precipitation condition of the XR environment.

The assets field 620 includes a second asset field 640. The second asset field 640 includes a second asset identifier field 640 that includes an asset identifier of the second asset. The second asset field 630 includes a second asset type field 642 that includes data indicating an asset type of the second asset. The second asset field 642 includes an optional asset subtype field 643 that includes data indicating an asset subtype of the asset type of the second asset.

The second asset field 640 includes a second asset states field 643 including a plurality of second asset state fields 645A and 645B. In various implementations, the assets state field 644 is based on the asset type and/or asset subtype of the second asset.

FIG. 6B illustrates a neural network model 680 associated with an asset in accordance with some implementations. The neural network model 680 receives, as an input, a current environmental state 601 and provides, as an output, one or more assets actions 690 reflected in a next environmental state (which may also be affected by one or more asset actions of other neural network models). For example, the one or more asset actions 690 can include a new motion vector of the asset.

In various implementations, the neural network model 680 includes an interconnected group of nodes. In various implementations, each node includes an artificial neuron that implements a mathematical function in which each input value is weighted according to a set of weights and the sum of the weighted inputs is passed through an activation function, typically a non-linear function such as a sigmoid, piecewise linear function, or step function, to produce an output value. In various implementations, the neural network model 680 is trained on training data 670 to set the weights. As described above, in various implementations, the training data 670 is generated based on a training focus and includes a plurality of training instances weighted according to the training focus.

In various implementations, the neural network model 680 includes a deep learning neural network. Accordingly, in some implementations, the neural network model 680 includes a plurality of layers (of nodes) between an input layer (of nodes) and an output layer (of nodes).

Although a neural network model 680 is illustrated in FIG. 6B, in various implementations, other machine learning models or other models are implemented.

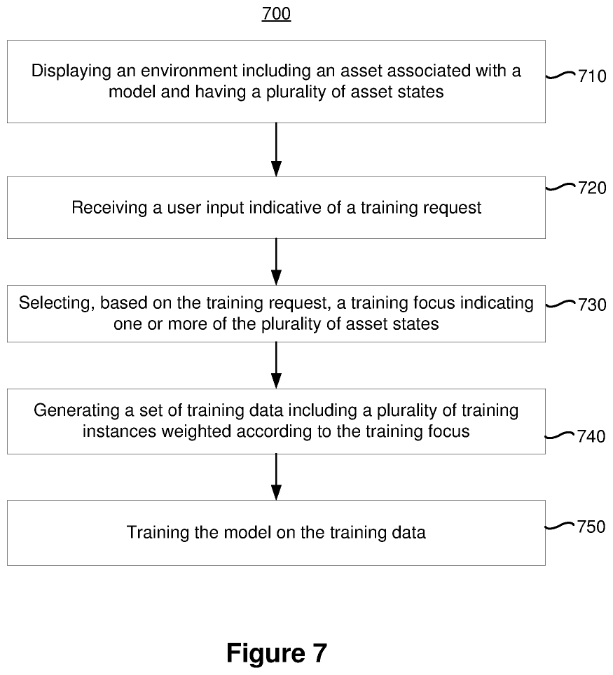

FIG. 7 is a flowchart representation of a method 700 of training a model of an asset in accordance with some implementations. In various implementations, the method 700 is performed by a device with one or more processors and non-transitory memory (e.g., the electronic device 120 of FIG. 3 or the electronic device 410 of FIG. 4). In some implementations, the method 700 is performed by processing logic, including hardware, firmware, software, or a combination thereof. In some implementations, the method 700 is performed by a processor executing instructions (e.g., code) stored in a non-transitory computer-readable medium (e.g., a memory). Briefly, in some circumstances, the method 700 receiving user input indicative of a training request, selecting a training focus based on the user input, and training the model (e.g., a machine learning model, such as a neural network model) on a set of training data based on the training focus.

The method 700 begins, in block 710, with the device displaying an environment including an asset associated with a model and having a plurality of asset states. For example, in FIG. 5D, the electronic device 410 displays the XR environment 409 including the dog 521. The dog 521 is associated with a neural network model and has asset states including an asset state of “chewing”, an asset state of “holding the rock” 513, an asset state of “lying down”, and an asset state of “being near the tree” 511.

The method 700 continues, in block 720, with the device receiving a user input indicative of a training request. For example, in FIG. 5E, the electronic device 410 receives a user input including speech indicative of a training request.

In various implementations, the user input indicative of a training request includes speech produced by a user. In various implementations, the user input indicative of a training request includes text input by a user. In various implementations, the user input indicative of a training request includes video selected and/or provided by a user. In various implementations, the user input indicative of a training request includes selection of a user interface element (e.g., a thumps-up affordance or a thumbs-down affordance).

In various implementations, the user input indicative of a training request is a binary positive/negative indication. For example, in various implementations, the user input indicative of a training request includes speech (e.g., “good dog”) indicating a training request to positively weight current asset states or speech (e.g., “bad dog”) to negatively weight current asset states.

In various implementations, the user input indicative of a training request indicates an asset state. For example, in various implementations, the user input indicative of a training request includes speech (e.g., “lie down”) indicating a training request to positively weight a specific asset state (e.g. “lying down”) or speech (e.g., “don't go in the mud”) indicative a training request to negatively weight a specific asset state (e.g., “be in the mud”).

In various implementations, the user input indicative of a training request includes video indicating a training request to positively weight one or more asset states associated with the video. For example, the video can include video of a dog running and the electronic device can interpret the user input as a user input indicative of a training request to positively weight an asset state of “running”.

The method 700 continues, at block 730, with the device selecting, based on the user input, a training focus indicating one or more of the plurality of asset states. As noted above, in various implementations, the user input includes speech. Thus, in various implementations, the device converts the speech to a text representation of the speech and parses the text representation of the speech with a natural language parsing algorithm to identify one or more of the plurality of asset states. The device selects the training based on the identified one or more of the plurality of asset states. For example, as illustrated in FIG. 5G, the user produces speech of “Don't chew rocks” and the device parses the text representation of the speech to identify the asset states of “chewing” and “holding a rock”. Accordingly, the device selects the training focus as “don't chew AND hold a rock”.

As also noted above, in various implementations, the user input includes video. Thus, in various implementations, the device performs video analysis on the video to identify one or more of the plurality of asset states. The device selects the training based on the identified one or more of the plurality of asset states. For example, the user provides video of a dog lying down and the device performs video analysis on the video to identify the asset state of “lying down”. Accordingly, the device selects the training focus as “lie down”.

In various implementations, selecting the training focus includes determining a plurality of candidate training focuses, each indicating a different set of one or more of the plurality of asset states and selecting one of the plurality of candidate training focuses as the training focus. For example, in FIG. 5E, the dog 521 has asset states including an asset state of “chewing”, an asset state of “holding the rock” 513, an asset state of “lying down”, and an asset state of “being near the tree” 511.

In various implementations, at least one of the plurality of candidate training focuses indicates a single one of the plurality of asset states. Thus, in various implementations, the candidate training focuses include “don't chew”; “don't hold the rock”; “don't lie down”; and “don't be near the tree”. In various implementations, at least one of the plurality of candidate training focuses indicates two or more of the plurality of asset states. Thus, in various implementations, the candidate training focuses include “don't chew AND hold the rock”; “don't chew AND lie down”; “don't lie down AND be near the tree.”

In various implementations, the selecting one of the plurality of candidate training focuses as the training focus includes ranking the plurality of candidate training focuses and selecting one of the candidate training focuses based on the ranking. In various implementations, the ranking is based on asset state recency. For example, in FIG. 5E, the candidate training focus of “don't chew” is ranked higher than “don't hold the rock” because the asset state of “chewing” occurred more recently than the asset state of “holding the rock”. In various implementations, the ranking is based on the user input. For example, in various implementations, the user input indicates a training focus, e.g., “Don't eat that” rather than “Don't do that” as shown in FIG. 5E. Accordingly, the candidate training focus of “don't chew” is ranked higher than “don't lie down” because the asset state of “chewing” is semantically related to “eat” and “lying down” is not.

In various implementations, selecting the training focus includes selecting a potential training focus indicating one or more of the plurality of asset states and presenting a natural language confirmation of the potential training focus. For example, in FIG. 5F, the electronic device 410 presents a natural language confirmation of the potential training focus of “don't chew”.

In various implementations, selecting the training focus includes receiving a user input confirming the potential training focus and selecting the potential training focus as the training focus. For example, in FIG. 5I, the electronic device 410 receives a user input confirming the potential training focus of “don't chew AND hold a rock”.

In various implementations, selecting the training focus includes receiving a user input modifying the potential training focus and selecting the modified potential training focus as the training focus. For example, in FIG. 5G, the electronic device 410 receives a user input modifying the potential training focus of “don't chew” to “don't chew AND hold a rock”.

The method 700 continues, at block 740, with the device generating a set of training data including a plurality of training instances weighted according to the training focus. In particular, the device generates a plurality of simulations of behavior of the asset and assigns weights according to the training focus, wherein, if the training request is a positive training request, simulations in which the training focus occurs are weighted positively and/or simulations in which the training focus does not occur are weighted negatively or, if the training request is a negative training request, simulations in which the training focus occurs are weighted negatively and./or simulations in which the training focus does not occur are weighted positively.

The method 700 continues, at block 750, with the device training the model on the set of training data. In various implementations, the model is a neural network model including an interconnected group of nodes. In various implementations, each node includes an artificial neuron that implements a mathematical function in which each input value is weighted according to a set of weights and the sum of the weighted inputs is passed through an activation function, typically a non-linear function such as a sigmoid, piecewise linear function, or step function, to produce an output value. In various implementations, the neural network model is trained on the training data to set (or re-set) the weights.

In various implementations, the neural network model includes a deep learning neural network. Accordingly, in some implementations, the neural network model includes a plurality of layers (of nodes) between an input layer (of nodes) and an output layer (of nodes).

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at an electronic device including a processor and non-transitory memory:
displaying an environment including an asset associated with a model and having a plurality of asset states;
receiving a user input indicative of a training request;
selecting, based on the user input, a training focus indicating one or more of the plurality of asset states;
generating a set of training data including a plurality of training instances weighted according to the training focus; and
training the model on the set of training data.

2. The method of claim 1, wherein the user input includes speech.

3. The method of claim 2, wherein selecting the training focus includes:
converting the speech to a text representation of the speech;
parsing the text representation of the speech with a natural language parsing algorithm to identify one or more of the plurality of asset states; and
selecting the training focus based on the identified one or more of the plurality of asset states.

4. The method of claim 1, wherein the user input indicates a video.

5. The method of claim 4, wherein selecting the training focus includes:
performing video analysis on the video to identify one or more of the plurality of asset states; and
selecting the training focus based on the identified one or more of the plurality of asset states.

6. The method of claim 1, wherein selecting the training focus includes:
determining a plurality of candidate training focuses, each indicating a different set of one or more of the plurality of asset states; and
selecting one of the plurality of candidate training focuses as the training focus.

7. The method of claim 6, wherein at least one of the plurality of candidate training focuses indicates a single one of the plurality of asset states.

8. The method of claim 6, wherein at least one of the plurality of candidate training focuses indicates a function of two or more of the plurality of asset states.

9. The method of claim 6, wherein selecting one of the plurality of candidate training focuses as the training focus includes:
ranking the plurality of candidate training focuses; and
selecting one of the candidate training focuses as the training focus based on the ranking.

10. The method of claim 9, wherein ranking the plurality of candidate training focuses is based on asset state recency.

11. The method of claim 9, wherein ranking the plurality of candidate training focuses is based on the user input.

12. The method of claim 1, wherein selecting the training focus includes:
selecting a potential training focus indicating one or more of the plurality of asset states; and
presenting a natural language confirmation of the potential training focus.

13. The method of claim 12, wherein selecting the training focus further includes receiving a user input confirming the potential training focus and selecting the potential training focus as the training focus.

14. The method of claim 12, wherein selecting the training focus further includes receiving a user input modifying the potential training focus and selecting the modified potential training focus as the training focus.

15. The method of claim 12, wherein selecting the training focus further includes receiving a user input negating the potential training focus and selecting a different potential training focus as the training focus.

16. The method of claim 1, wherein the model includes a neural network model.

17. A device comprising:
a non-transitory memory; and
one or more processors to:
display an environment including an asset associated with a model and having a plurality of asset states;
receive a user input indicative of a training request;
select, based on the user input, a training focus indicating one or more of the plurality of asset states;
generate a set of training data including a plurality of training instances weighted according to the training focus; and
train the model on the set of training data.

18. The device of claim 17, wherein the user input includes speech and the one or more processors are to select the training focus by:
converting the speech to a text representation of the speech;
parsing the text representation of the speech with a natural language parsing algorithm to identify one or more of the plurality of asset states; and
selecting the training focus based on the identified one or more of the plurality of asset states.

19. The device of claim 17, wherein the one or more processors are to select the training focus by:
determining a plurality of candidate training focuses, each indicating a different set of one or more of the plurality of asset states; and
selecting one of the plurality of candidate training focuses as the training focus.

20. A non-transitory memory storing one or more programs, which, when executed by one or more processors of a device, cause the device to:
display an environment including an asset associated with a model and having a plurality of asset states;
receive a user input indicative of a training request;
select, based on the user input, a training focus indicating one or more of the plurality of asset states;
generate a set of training data including a plurality of training instances weighted according to the training focus; and
train the model on the set of training data.
